(19) United States
(12) Patent Application Publication
(10) Pub. No.: US 2009/0281813 A1
(43) Pub. Date: Nov. 12, 2009

(54) NOISE SYNTHESIS

(75) Inventors: Andreas Gerrits, Oeffelt (NL); Marek Szczerba, Eindhoven (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/306,611

(22) PCT Filed: Jun. 27, 2007
(86) PCT No.: PCT/IB2007/052492

§ 371 Date: Dec. 24, 2008

(30) Foreign Application Priority Data
Jun. 29, 2006 (EP) 06116309.3

(51) Int. Cl. G10L 21/00

(52) U.S. Cl. 704/500

(57) ABSTRACT

A device (1) for producing spectrally shaped noise comprises a filter unit (13) for filtering input noise samples using filter coefficients representing a spectral envelope. The filter coefficients are determined for use at a first sampling frequency, while the spectrally shaped noise is reproduced using the same filter coefficients at a second, different sampling frequency. The noise spectrum may further be altered by an upsampling unit (14).

### BACKGROUND OF THE INVENTION

The present invention relates to noise synthesis. More in particular, the present invention relates to a device for and a method of noise synthesis which is substantially independent of the sampling rate.

In sound synthesizers and (parametric) decoders noise has to be synthesized. This may be accomplished by producing random noise and shaping the noise using a set of parameters, which may include but are not limited to one or more gain parameters, temporal envelope parameters and spectral envelope parameters. The noise samples generated by the random noise generator may be processed by a temporal shaping unit and/or a spectral shaping unit for shaping the temporal and spectral envelope of the noise signal respectively.

The spectral shaping unit typically comprises a shaping filter, the filter coefficients of which are determined for a certain sampling frequency, for example 44.1 kHz (the CD sampling frequency). However, various data storage formats are used in practice, many having their own sampling frequency, for example 16.0 kHz or 48.0 kHz, thus making it necessary to convert sound signals from one sampling frequency to another sampling frequency. To this end, sampling rate converters are available. However, sampling rate converters are relatively expensive, adding significantly to the cost of devices in which they are utilized. Alternatively, the filter coefficients can be re-calculated to match the new sampling frequency. However, re-computing filter coefficients is complex and requires a significant amount of processing.

### SUMMARY OF THE INVENTION

It is an object of the present invention to overcome these and other problems of the Prior Art and to provide a device for and method of producing noise, in particular spectrally shaped noise, which is able to produce noise at various sampling frequencies without using a sampling rate converter or re-computing the filter coefficients.

Accordingly, the present invention provides a device for producing spectrally shaped noise, the device comprising a filter unit for filtering input noise samples using filter coefficients representing a spectral envelope, wherein the filter coefficients are determined for use at a first sampling frequency, and wherein the spectrally shaped noise is reproduced using the same filter coefficients at a second, different sampling frequency.

By using the spectral envelope filter at a different sampling frequency, it is possible to produce noise at a different sampling frequency without the need for a sampling frequency converter. The inventors have found that operating the spectral envelope filter at a different frequency is very well possible without a noticeably affecting the sound quality, provided the difference between the first and the second sampling frequency is not too large, for example less than 50% of the first sampling frequency. Accordingly, a filter designed to operate at 16.0 kHz can, in accordance with the present invention, be used at 22.0 kHz (+37.5%).

If larger deviations from the original or first sampling frequency are desired, the sampling frequency can effectively be doubled or quadrupled by upsampling, thus increasing the number of noise samples. Upsampling may be carried out by the insertion of zeroes between the noise samples, and subsequent filtering, as is known per se. Accordingly, the upsampling may be followed by further spectral shaping using shaping filter coefficients to reduce aliazing effects.

As mentioned above, in the present invention upsampling is not used when the desired deviation from the original sampling frequency is relatively small.

In accordance with an important further aspect of the present invention, the two techniques mentioned above may be combined to allow further sampling frequency adjustments. If a filter designed for use at 16.0 kHz is to be used at 44.1 kHz, for example, the present invention teaches to (1) double the sampling rate by upsampling to arrive at 32.0 kHz, and then (2) use the 32.0 kHz noise samples at 44.1 kHz.

The device according to the present invention may further comprise a temporal envelope shaping unit and an overlap-and-add unit. The filter unit preferably comprises a frequency-warped filter, such as a Laguerre filter.

The present invention also provides a consumer device comprising a device as defined above, such as a mobile telephone device or a portable audio device, and an audio system comprising a device as defined above.

The present invention further provides a method of producing spectrally shaped noise, the method comprising the steps of:

receiving noise samples,

filtering the received noise samples using filter coefficients representing a spectral envelope, and

outputting the filtered noise samples, wherein the filter coefficients are determined for use at a first sampling frequency, and wherein the spectrally shaped noise is reproduced using the same filter coefficients at a second, different sampling frequency.

The number of noise samples may be increased by upsampling, and the upsampling may be followed by further spectral shaping using shaping filter coefficients, preferably low-pass filtering. However, the number of samples may also remain constant.

The present invention additionally provides a computer program product for carrying out the method as defined above. A computer program product may comprise a set of computer executable instructions stored on a data carrier, such as a CD or a DVD. The set of computer executable instructions, which allow a programmable computer to carry out the method as defined above, may also be available for downloading from a remote server, for example via the Internet.

### BRIEF DESCRIPTION OF THE DRAWINGS

The present invention will further be explained below with reference to exemplary embodiments illustrated in the accompanying drawings, in which:

FIG. 1 schematically shows a first embodiment of a device according to the present invention.

FIG. 2 schematically shows a second embodiment of a device according to the present invention.

FIG. 3 schematically shows a first exemplary upsampling filter which may be used in the embodiment of FIG. 2.

FIG. 4 schematically shows a second exemplary upsampling filter which may be used in the embodiment of FIG. 2.

FIG. 5 schematically shows the steps of increasing the sampling frequency according to the present invention.

### DETAILED DESCRIPTION OF PREFERRED EMBODIMENTS

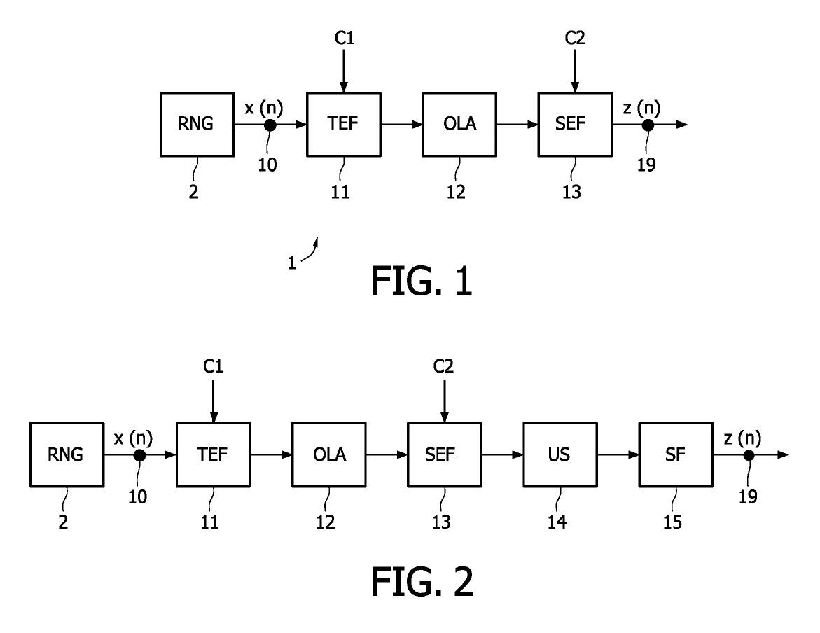

The noise production device 1 shown merely by way of non-limiting example in FIG. 1 comprises a temporal envelope filter (TEF) unit 11, an overlap-and-add (OLA) unit 12, and a spectral envelope filter (SEF) unit 13. An input terminal 10 receives a random noise signal x(n) generated by random noise generator 2. Although the random noise generator 2 is shown as an external unit, it may also be incorporated in the device 1.

The temporal envelope filter unit 11 also receives first or temporal envelope parameters c1, which define one or more temporal envelopes. The filter unit 11 effectively shapes the temporal envelope of the random noise x(n) in accordance with the first parameters c1.

The random noise signal x(n) may consist of samples arranged in frames. The overlap-and-add (OLA) unit 12 adds the (temporally shaped) samples of overlapping frames to produce a signal that is fed to the spectral envelope filter (SEF) unit 13, which unit also receives second or spectral envelope parameters c2. The both temporally and spectrally shaped noise signal z(n) is output at output terminal 19.

The spectral envelope unit 13 typically contains a filter, for example a Laguerre filter, for imposing the desired spectral envelope upon the noise signal. The filter parameters are defined by, or equal to, the second parameters c2. Digital filters are designed to operate at a certain sampling rate, which will be referred to as the design sampling frequency (DSF) or design sampling rate. That is, the filter parameters are calculated so as to produce a certain filter characteristic at the design sampling frequency. When another sampling frequency is used, the resulting envelope will have shifted along the frequency axis.

In accordance with the present invention, the spectral envelope filter is used at another sampling frequency, the operating sampling frequency, that the one for which the filter is designed. The present inventors have found that, within certain limits, this will still yield satisfactory results. In particular, the actual or operating sampling frequency may be at most 50% higher or lower than the design sampling frequency, although it is preferred that this difference is at most 40%.

Using the present invention, the spectral envelope filter may for example be designed for use at 16.0 kHz and be actually used at both 16.0 and 22.05 kHz.

If the difference between the design sampling frequency and the operating sampling frequency is more than 50%, it is preferred that the embodiment of FIG. 2 is used, in which upsampling is utilized. The embodiment of FIG. 2 is essentially identical to the embodiment of FIG. 1, with the exception of the added upsampling (US) unit 14 and shaping filter (SF) unit 15. The upsampling unit 14 upsamples the noise by inserting zeroes between the samples. The insertion of a single zero between adjacent samples results in a doubling of the sampling frequency, while the insertions of two zeroes between each pair of samples effectively triples the sampling frequency. The upsampling introduces undesired spectral components which are removed by the shaping filter 15.

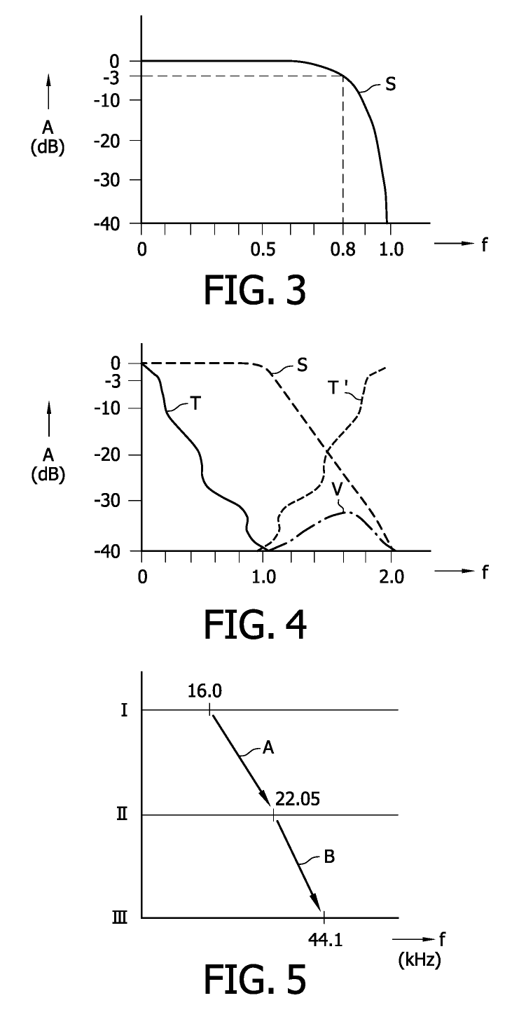

A suitable shaping filter characteristic of the (upsampling) shaping filter 15 is illustrated in FIG. 3. The amplitude A (in dB) is shown as a function of the normalized frequency f, the value f=1 corresponding with half the original (that is, designed) sampling frequency, which corresponds with the original Nyquist frequency. It can be seen that in this example the amplitude of the low-pass filter characteristic S reaches the −3 dB value at f=0.8. As a result, any aliazing components will be suppressed, as these components extend above the original Nyquist frequency.

Another suitable shaping filter characteristic of the (upsampling) shaping filter 15 is illustrated in FIG. 4. The amplitude A (in dB) is again shown as a function of the normalized frequency f, the value f=1 corresponding with half the original (that is, designed) sampling frequency, which corresponds with the original Nyquist frequency. In the example shown, the sampling frequency used will be doubled. As a result, the new Nyquist frequency will correspond with the value f=2.0, which value also corresponds (in the present example) with the original sampling frequency.

In the example of FIG. 4, the amplitude of the low-pass filter characteristic S is essentially constant between f=0 and f=1.0, and then gradually drops to approximately −40 dB at f=2.0. As a result, aliazing components are suppressed only partially. In FIG. 4, the original noise spectrum T is shown, together with the added spectrum T′ caused by aliazing due to the insertion of zeroes. The filter characteristic S of FIG. 4 suppresses these aliazing components T′ only partially, resulting in the high frequency spectrum part V. As can be seen, due to the insertion of zeroes the spectrum is effectively extended from f=1.0 to f=2.0, using aliazing components T′ of the original spectrum T. In this way, an extended frequency spectrum can be produced.

The method of the present invention is illustrated in FIG. 5, where a filter designed for a sampling frequency of 16.0 kHz is used at 44.1 kHz.

Starting from stage I and a sampling frequency of 16.0 kHz, the frequency spectrum is effectively shifted by applying the 22.05 kHz sampling frequency (step A) in stage II, and then doubling the sampling frequency (step B) to arrive at a sampling frequency of 44.1 kHz in stage III. The doubling of the sampling frequency is achieved by the upsampling and subsequent filtering described above.

The present invention is based upon the insight that a filter, in particular a spectral envelope filter, can be operated at a sampling frequency different from its design sampling frequency. The present invention benefits from the further insight that upsampling may advantageously be used to effectively decrease the difference between the operating sampling frequency for which the filter was designed, and the operating frequency at which the filter is actually operated.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. A device for producing spectrally shaped noise, the device comprising a filter unit for filtering input noise samples using filter coefficients representing a spectral envelope, wherein the filter coefficients are determined for use at a first sampling frequency, and wherein the spectrally shaped noise is reproduced using the same filter coefficients at a second, different sampling frequency.

2. The device according to claim 1, comprising an upsampling unit for upsampling the noise samples.

3. The device according to claim 2, wherein the upsampling is followed by further spectral shaping using shaping filter coefficients.

4. The device according to claim 1, further comprising a temporal envelope shaping unit and an overlap-and-add unit.

5. The device according to claim 1, wherein the filter unit comprises a frequency-warped filter.

6. The device according to claim 5, wherein the frequency-warped filter is a Laguerre filter.

7-9. (canceled)

10. A method of producing spectrally shaped noise, the method comprising the steps of:
receiving noise samples,
filtering the received noise samples using filter coefficients representing a spectral envelope, and
outputting the filtered noise samples, wherein the filter coefficients are determined for use at a first sampling frequency, and wherein the spectrally shaped noise is reproduced using the same filter coefficients at a second, different sampling frequency.

11. The method according to claim 10, wherein the number of noise samples is increased by upsampling.

12. The method according to claim 11, wherein the upsampling is followed by further spectral shaping using shaping filter coefficients.

13. The method according to claim 10, wherein the filter coefficients are frequency-warped filter coefficients.

14. The method according to claim 13, wherein the filter coefficients are Laguerre filter coefficients.

15. The method according to claim 10, wherein the received noise samples are temporally shaped prior to the filtering.

16. (canceled)
